(19) United States
(12) Patent Application Publication
(10) Pub. No.: US 2005/0092174 A1
(43) Pub. Date: May 5, 2005

(54) Oilless reciprocating fluid machine

(75) Inventors: Hiroshi Inoue, Yokohama-shi (JP); Toshio Iida, Yokohama-shi (JP)

Correspondence Address: MCKEE, VOORHEES & SEASE, P.L.C., 801 GRAND AVENUE, SUITE 3200, DES MOINES, IA, 50309-2721, US

(73) Assignee: ANEST IWATA CORPORATION, Yokohama-shi (JP)

(21) Appl. No.: 10/968,210

(22) Filed: Oct. 19, 2004

(30) Foreign Application Priority Data
Oct. 31, 2003 (JP) 2003-373561

(51) Int. Cl. F16J 1/00

(52) U.S. Cl. 92/187

(57) ABSTRACT

An oilless reciprocating fluid machine has a piston mounted to a connecting rod by inserting a piston pin in a pin bore of a cylinder. The piston is reciprocally moved up and down in the cylinder with reciprocating of the connecting rod. A reinforcement plate is embedded in the top wall of the piston or attached on the lower surface of the top wall to increase strength of the piston. The reinforcement plate may be formed in various shapes.

### BACKGROUND OF THE INVENTION

The present invention relates to an oilless reciprocating fluid machine in which fluid is compressed or decompressed by reciprocating a piston in a cylinder through a crank rod and a piston pin.

FIG. 25 shows a conventional oilless reciprocating fluid machine. In an Al alloy cylinder 51 having cooling fins 50 on the outer circumference, a self-lubricating synthetic resin piston 57 is slidably fitted. The piston 57 has a self-lubricating piston ring 52 on the outer circumference. A piston pin 56 is fixed in an annular portion 55 of a connecting rod 54 which can be reciprocated by power (not shown), and the ends of the piston pin 56 are supported in a pair of radial pin bores 53,53 of a middle portion.

The piston 57 is made of self-lubricating resin composites in which heat resistant material for increasing slidability such as graphite is mixed with strength-increasing material such as carbon fiber.

The piston made of self-lubricating and heat resistant synthetic resin avoids fouling or seizure to keep a long-time operation thereafter even if the outer circumference of the piston is directly engaged with the inner surface of the cylinder owing to wear of the piston ring during a long-time operation.

However, synthetic resin piston has strength about a half or a quarter less than Al alloy piston. To bear operational pressure equal to that applied to a fluid machine that comprises an Al alloy piston, it is necessary to provide thickness of a top wall of a piston with two to four times more than Al alloy.

Specifically, when the top wall of an Al alloy piston having an external diameter of 100 mm, length of 80 mm and thickness of a middle portion of about 9 mm is about 7 mm thick, the top wall of synthetic resin piston having the same external diameter needs to be about 14 to 28 mm thick.

In the piston having much thicker top wall than the conventional piston, the following disadvantages are likely to occur.

During molding, defects such as cavities and nonuniforms are involved within the top wall to decrease strength. The longer the distance between a pin bore and the top of the piston is, the more oscillation during reciprocation of the piston occurs, thereby increasing wear of a piston ring and hitting the piston against the inner surface of the cylinder for a relatively short time to cause higher sound in operation.

To prevent such oscillation, it is necessary to extend the distance between the pin bore and the lower end of the piston in coincidence with increased distance between the pin bore and the top of the piston, but the whole height of the piston is increased, so that weight and cost are increased.

Thus, without increasing thickness of the top wall of the synthetic resin piston, it is necessary to attain strength of the top wall enough to withstand pressure applied to the inside of the cylinder.

### SUMMARY OF THE INVENTION

In view of the disadvantages in the prior art, an object of the invention is to provide an oilless reciprocating fluid machine comprising a piston that provides high strength of the top wall without changing thickness.

### BRIEF DESCRIPTION OF THE DRAWINGS

The foregoing and other features and advantages of the invention will become more apparent from the following description with respect to embodiments as shown in appended drawings wherein:

FIG. 1 is a vertical sectional front view of the first embodiment of an oilless reciprocating fluid machine according to the present invention;

FIG. 2 is a vertical sectional front view of the second embodiment of an oilless reciprocating fluid machine according to the present invention;

FIG. 3 is a vertical sectional front view of the third embodiment of an oilless reciprocating fluid machine according to the present invention;

FIG. 4 is a vertical sectional front view of the fourth embodiment of an oilless reciprocating fluid machine according to the present invention;

FIG. 5 is a vertical sectional front view of the fifth embodiment of an oilless reciprocating fluid machine according to the present invention;

FIG. 6 is a vertical sectional front view of the sixth embodiment of an oilless reciprocating fluid machine according to the present invention;

FIG. 7 is a vertical sectional front view of the seventh embodiment of an oilless reciprocating fluid machine according to the present invention;

FIG. 8 is a vertical sectional front view of the eighth embodiment of an oilless reciprocating fluid machine according to the present invention;

FIG. 9 is a vertical sectional front view of the ninth embodiment of an oilless reciprocating fluid machine according to the present invention;

FIG. 10 is a vertical sectional front view of the tenth embodiment of an oilless reciprocating fluid machine according to the present invention;

FIG. 11 is a vertical sectional front view of the eleventh embodiment of an oilless reciprocating fluid machine according to the present invention;

FIG. 12 is a vertical sectional front view of the twelfth embodiment of an oilless reciprocating fluid machine according to the present invention;

FIG. 13 is a vertical sectional front view of the thirteenth embodiment of an oilless reciprocating fluid machine according to the present invention;

FIG. 14 is a vertical sectional front view of the fourteenth embodiment of an oilless reciprocating fluid machine according to the present invention;

FIG. 15 is a perspective view of a reinforcement plate in which a number of irregularities are formed on its outer circumference;

FIG. 16 is a perspective view of a reinforcement plate having an upper rough surface;

FIG. 17 is a perspective view of a rough reinforcement plate in which a number of slits extends radially from the outer circumference;

FIG. 18 is a perspective view of a reinforcement plate in which a number of protrusions extends radially from the outer circumference;

FIG. 19 is a perspective view of a reinforcement plate in which a number of annular protrusions are concentrically formed on the upper surface;

FIG. 20 is a perspective view of a reinforcement plate in which a number of annular grooves are concentrically formed on the upper surface;

FIG. 21 is a perspective view of a reinforcement plate in which a number of annular and radial protrusions are formed on the upper surface;

FIG. 22 is a perspective view of a porous reinforcement plate;

FIG. 23 is a perspective view of a mesh-like reinforcement plate;

FIG. 24 is a perspective view of a fiber-containing reinforcement plate; and

FIG. 25 is a vertical sectional front view of a known an oilless reciprocating fluid machine.

### DETAILED DESCRIPTION OF PREFERRED EMBODIMENTS

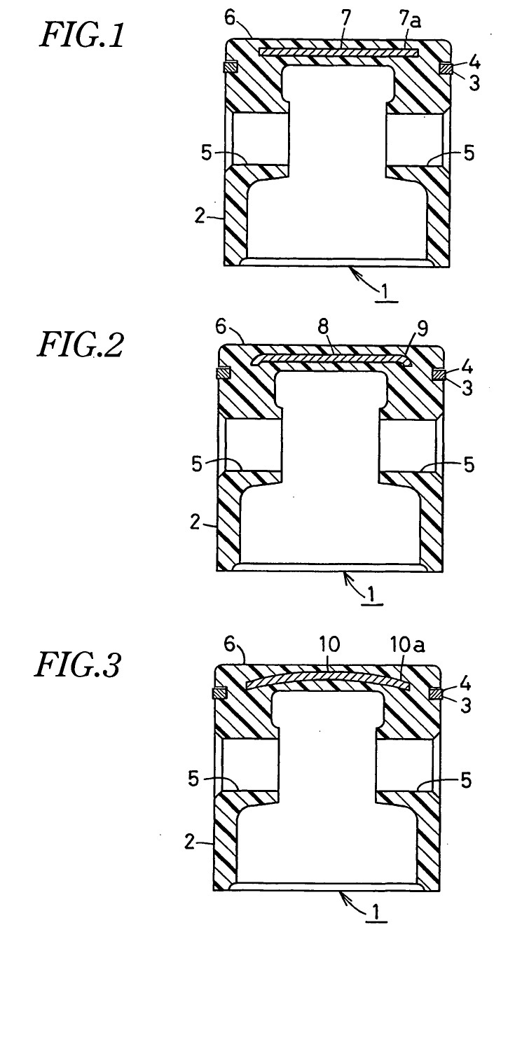

FIG. 1 shows the first embodiment of the present invention. A piston 1 made of self-lubricant and heat-resistant synthetic resin has in the vicinity of the upper end a circumferential groove 4 in which a piston ring 3 made of self-lubricant material is engaged, and in a middle portion 2, pin bores 5,5 face each other radially.

In a top wall 6 of the piston 1, a flat disc-like reinforcement plate 7 made of iron, stainless steel, Ti or other metals, carbon-fiber-containing resin or other resins that have higher strength than the piston 1 or ceramics is embedded-such that a circumferential portion 7a is positioned above the middle portion 2. The circumferential portion 7a of the reinforcement plate 7 need not to reach above the middle portion 2.

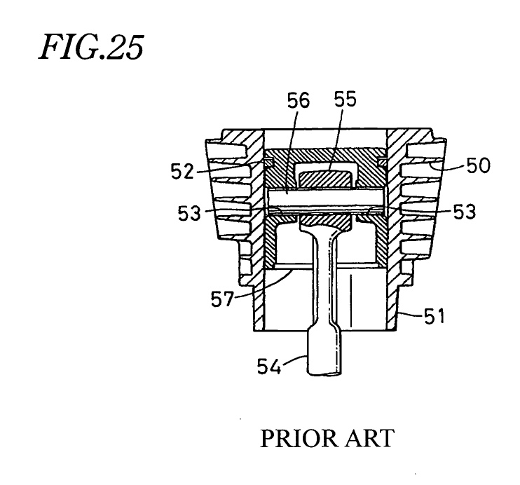

In FIGS. 2 to 25, the same numerals are allotted to the same parts as those in FIG. 1, and only differences will be described.

FIG. 2 shows the second embodiment of the present invention. A reinforcement plate 8 embedded in a top wall 6 of a piston 1 has a downward-curving flange 9 at the circumference.

FIG. 3 shows the third embodiment of the present invention. A reinforcement plate 10 has a circumferential portion 10a above a middle portion 2 of a piston 1 and is convex.

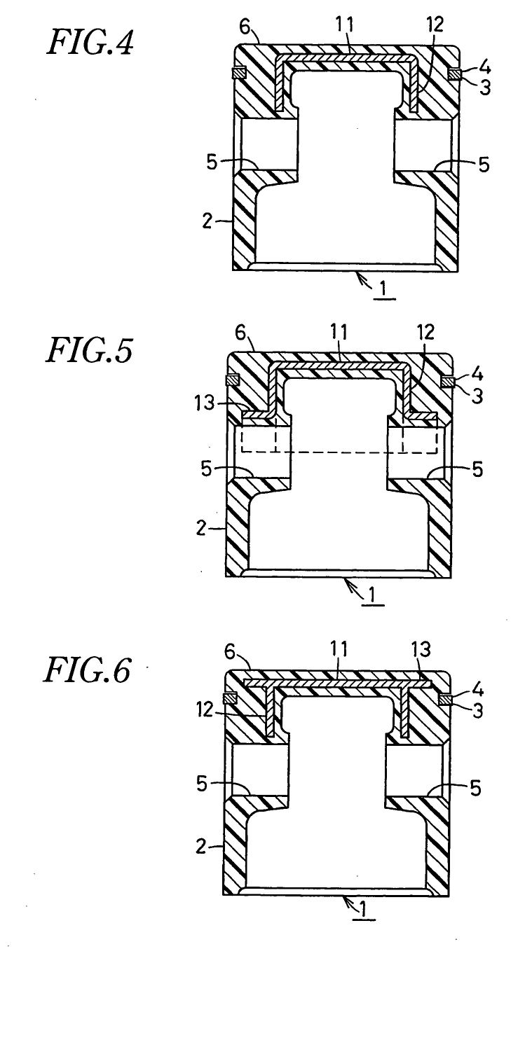

FIG. 4 shows the fourth embodiment of the present invention. A reinforcement plate 11 has a reinforcement tube 12 which protrudes downward in a middle portion 2 of a piston 1.

FIG. 5 shows the fifth embodiment of the present invention. A reinforcement plate 11 has a reinforcement tube 12 which has a semicylindrical support portion 13 at the lower end. The support portion 13 surrounds an upper half of a pin bore 5 of a middle portion 2 of a piston 1.

FIG. 6 shows the sixth embodiment of the present invention. A reinforcement plate 11 has a circumferential portion 13 which protrudes horizontally from a reinforcement tube 12.

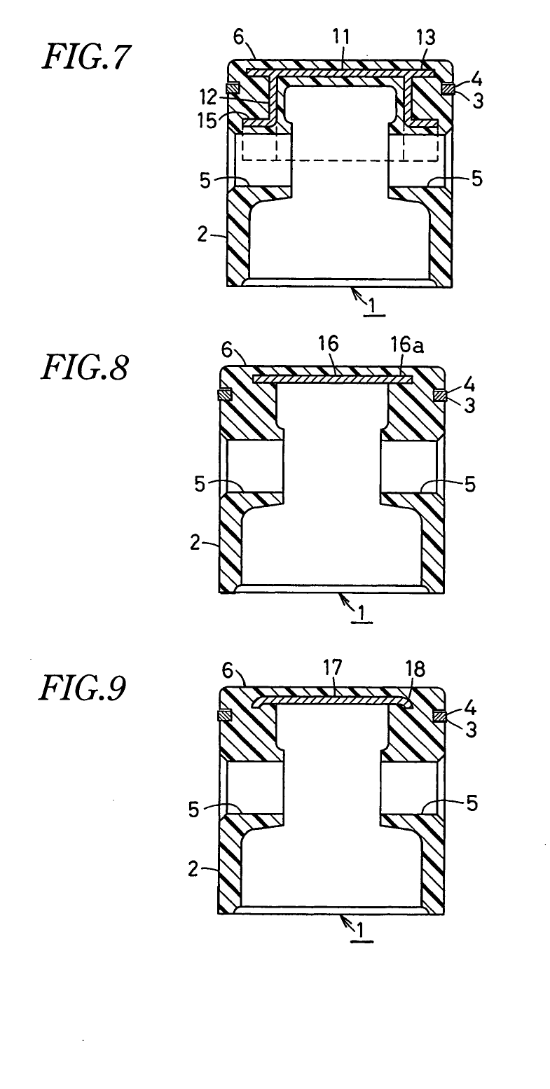

FIG. 7 shows the seventh embodiment of the present invention. At the lower end of a reinforcement tube 12, a semicylindrical support portion 15 is provided over the upper half of a pin bore 5 of a middle portion 2.

FIG. 8 shows the eighth embodiment of the present invention. A reinforcement plate 16 is attached on the lower surface of a top wall 6 and the outer circumference of the reinforcement plate 15 reaches above a middle portion 2. The reinforcement plate 16 is integrally molded with a piston 1.

FIG. 9 shows the ninth embodiment of the present invention. The circumference of a reinforcement plate 17 is bent downward to form a flange 18.

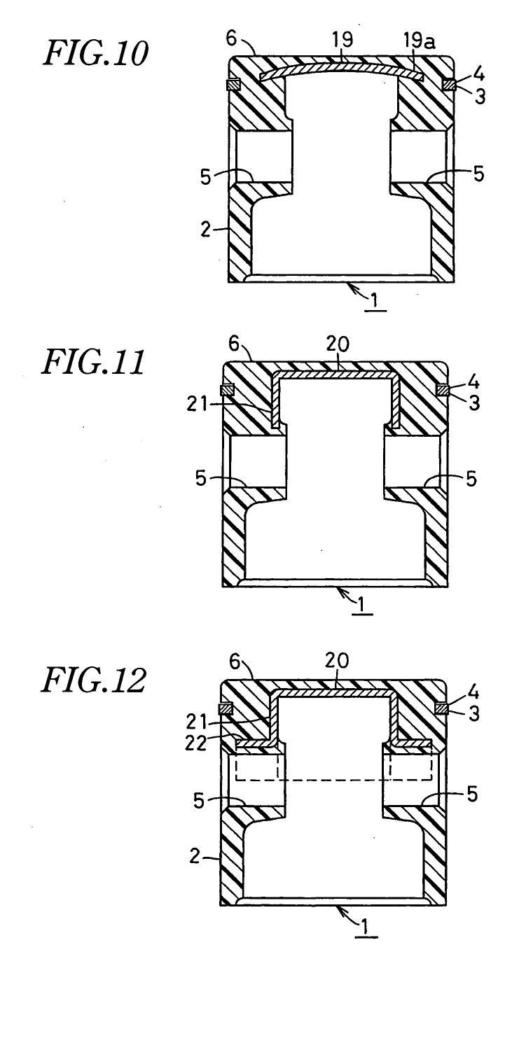

FIG. 10 shows the tenth embodiment of the present invention. A convex reinforcement plate 19 is attached to the lower surface of a top wall 76 of a piston 1 and reaches above a middle portion 2 of a piston 1.

FIG. 11 shows the eleventh embodiment of the present invention. The circumference of a reinforcement plate 20 has a reinforcement tube 21 which projects toward a middle portion 2 of a piston 1. The inner surface of the reinforcement tube 21 is exposed from the inner surface of the middle portion 2.

FIG. 12 shows the twelfth embodiment of the present invention. At the lower end of reinforcement tube 21, a semicylindrical support portion 22 is provided to surround an upper half of a middle portion 2.

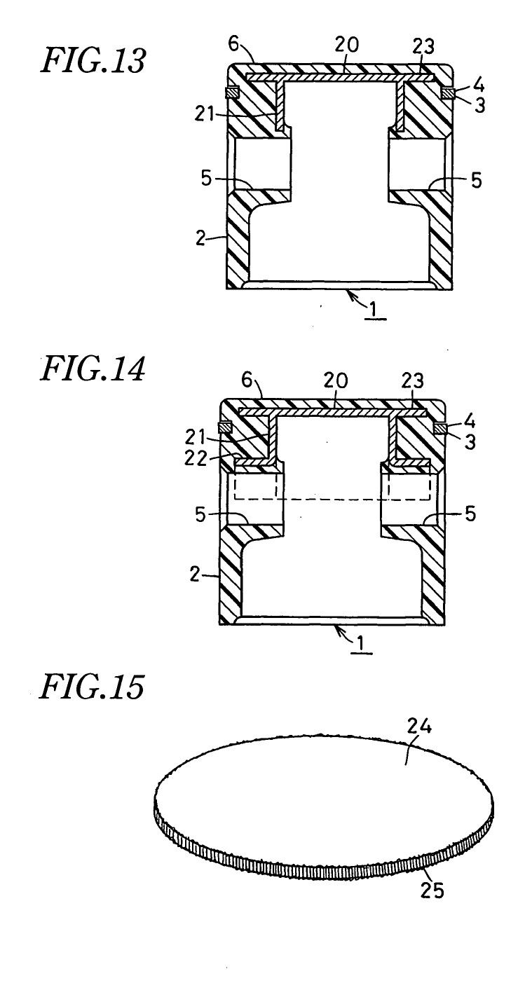

FIG. 13 shows the thirteenth embodiment of the present invention. A circumferential portion 23 of a reinforcement plate 20 protrudes horizontally from a reinforcement tube 21.

FIG. 14 shows the fourteenth embodiment of the present invention. A circumferential portion 23 of a reinforcement plate 20 protrudes from a reinforcement tube 21, and a semicylindrical support portion 22 extends horizontally from the lower end of the reinforcement tube 21 to surround an upper half of a pin bore 5.

FIG. 15 shows a reinforcement plate 24 in which a number irreguralities 25 are formed on its outer circumference.

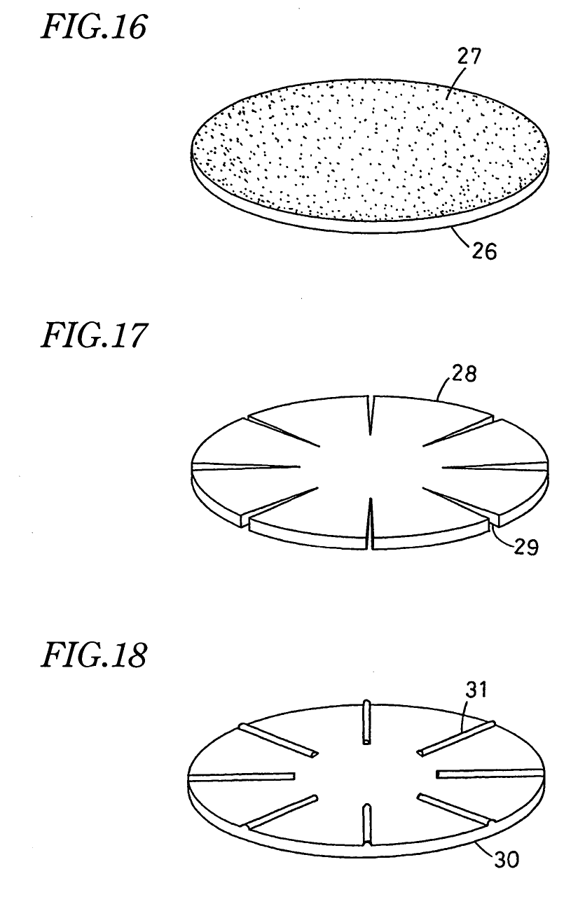

FIG. 16 shows a reinforcement plate 26 which has an upper rough surface 27.

FIG. 17 shows a reinforcement plate 28 in which a number of redial slits 29 extend from its outer circumference toward the center.

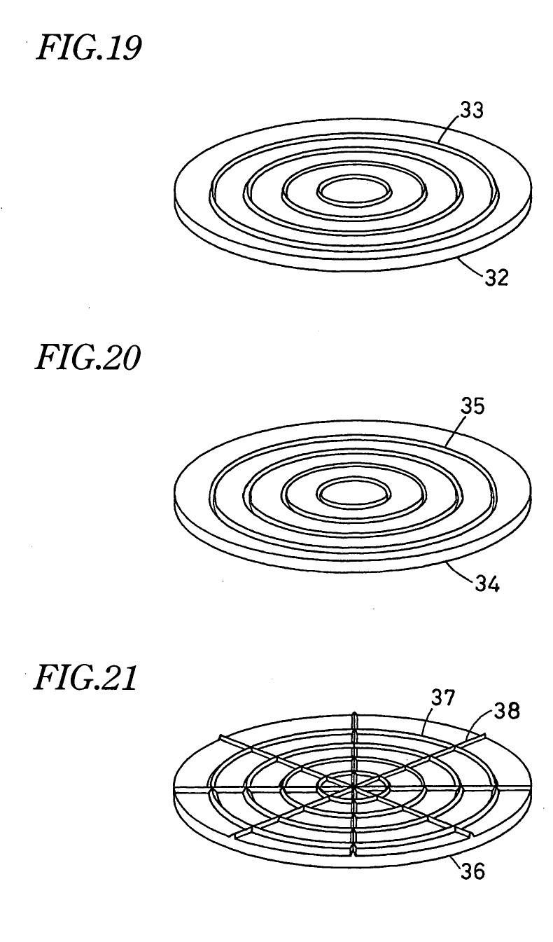

FIG. 18 shows a reinforcement plate 30 in which a number of radial protrusions 31 extend from its outer circumference toward the center on the upper surface.

FIG. 19 shows a reinforcement plate 32 in which a number of annular protrusions 22 are concentrically formed on the upper surface.

FIG. 20 shows a reinforcement plate 34 in which a number of annular grooves 35 are concentrically formed on the upper surface.

FIG. 21 shows a reinforcement plate 36 in which a number of annular protrusions 37 and redial protrusions 38 are formed on the upper surface.

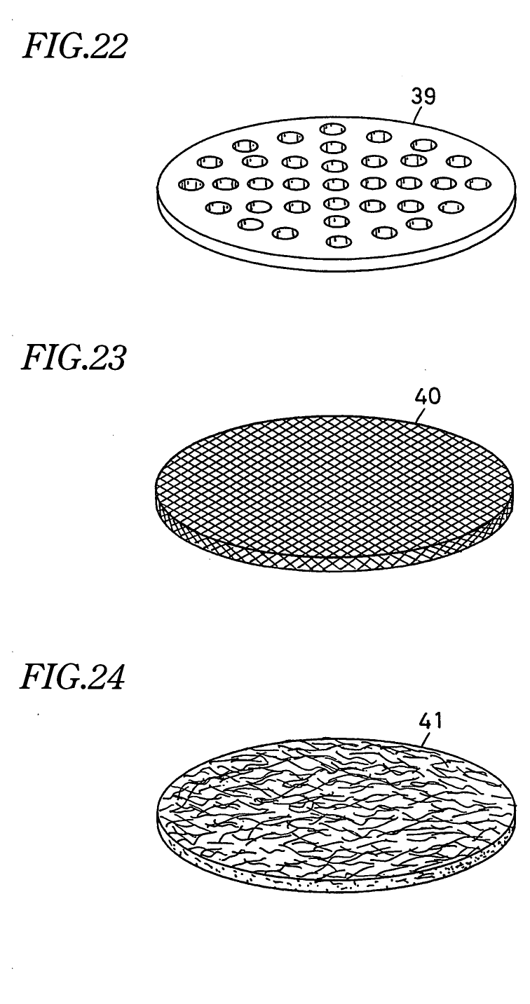

FIG. 22 shows a porous reinforcement plate 39.

FIG. 23 shows a reinforcement plate 40 that comprises a mesh plate made of metal or high-tensile resin.

FIG. 24 shows a reinforcement plate 41 that contains metallic or high-tensile-resin fibers.

In the reinforcement plate in FIGS. 16. 18. 19. 20, 21, 22 and 24, the lower surface may have those on the upper surface.

The foregoing merely relates to embodiments of the inventions. Various changes and modifications may be made by a person skilled in the art without departing from the scope of claims wherein:

1. An oilless reciprocating fluid machine comprising:
a piston made of self-lubricating and heat-resistant synthetic resin, comprising a top wall and a middle portion in which a pair of pin bores is formed;
a cylinder in which the piston is slidably fitted;
a connecting rod for reciprocating the piston; and
a piston pin that extends through an upper portion of the connecting rod and is fitted in the pair of the pin bores of the middle portion of the piston to reciprocally move the piston in the cylinder, a reinforcement plate that has more strength than the piston being embedded in the top wall of the piston.

2. An oilless reciprocating fluid machine as claimed in claim 1 wherein a circumference of the reinforcement plate reaches above the middle portion of the piston.

3. An oilless reciprocating fluid machine as claimed in claim 1 wherein a circumference of the reinforcement plate is bent downward to form a flange.

4. An oilless reciprocating fluid machine as claimed in claim 1 wherein the reinforcement plate is convex.

5. An oilless reciprocating fluid machine as claimed in claim 1 wherein a cylindrical tube is integrally formed downward from a circumference of the reinforcing plate to the middle portion of the piston.

6. An oilless reciprocating fluid machine as claimed in claim 5 wherein a semicylindrical support portion is integrally formed outward from a lower end of the reinforcement tube to surround an upper half of the pin bore.

7. An oilless reciprocating fluid machine as claimed in claim 5 wherein a circumferential portion extends outward horizontally from an upper end of the circumference of the reinforcement plate.

8. An oilless reciprocating fluid machine comprising:
a piston made of self-lubricating and heat-resistant synthetic resin, comprising a top wall and a middle portion in which a pair of pin bores is formed;
a cylinder in which the piston is slidably fitted;
a connecting rod for reciprocating the piston; and
a piston pin that extends through an upper portion of the connecting rod and is fitted in the pair of the pin bores of the middle portion of the piston to reciprocally move the piston in the cylinder, a reinforcement plate that has more strength than the piston being attached on a lower surface of the top wall of the piston.

9. An oilless reciprocating fluid machine as claimed in claim 8 wherein a circumference of the reinforcement plate is embedded above the middle portion of the piston.

10. An oilless reciprocating fluid machine as claimed in claim 8 wherein a circumference of the reinforcing plate is bent downward to form a flange.

11. An oilless reciprocating fluid machine as claimed in claim 8 wherein the reinforcement plate is convex.

12. An oilless reciprocating fluid machine as claimed in claim 8 wherein a reinforcement tube extends downward from a circumference of the reinforcement plate.

13. An oilless reciprocating fluid machine as claimed in claim 12 wherein a semicylindrical support portion extends substantially in parallel with the reinforcement plate from a lower end of the reinforcement tube to surround an upper half of the pin bore.

14. An oilless reciprocating fluid machine as claimed in claim 12 wherein a circumferential portion extends outward horizontally from the reinforcement plate.

15. An oilless reciprocating fluid machine as claimed in claim 14 wherein a semicylindrical support portion extends substantially in parallel with the reinforcement plate from a lower end of the reinforcement tube to surround an upper half of the pin bore.

16. An oilless reciprocating fluid machine as claimed in claim 1 wherein a number of irregularities are formed on an outer circumference of the reinforcing plate.

17. An oilless reciprocating fluid machine as claimed in claim 1 wherein a rough surface is formed on at least one side of the reinforcing plate.

18. An oilless reciprocating fluid machine as claimed in claim 1 wherein a number of radial slits are formed from an outer circumference toward a center in the reinforcement plate.

19. An oilless reciprocating fluid machine as claimed in claim 1 wherein a number of radial protrusions are formed from an outer circumference toward a center on at least one side of the reinforcing plate.

20. An oilless reciprocating fluid machine as claimed in claim 1 wherein a number of annular protrusions are concentrically formed on at lease one side of the reinforcement plate.

21. An oilless reciprocating fluid machine as claimed in claim 1 wherein a number of annular grooves are concentrically formed on at least one side of the reinforcement plate.

22. An oilless reciprocating fluid machine as claimed in claim 1 wherein a number of annular grooves and radial grooves are formed on, at least one side of the reinforcement plate.

23. An oilless reciprocating fluid machine as claimed in claim 1 wherein the reinforcement plate is made of metal.

24. An oilless reciprocating fluid machine as claimed in claim 1 wherein the reinforcement plate is made of resin.

25. An oilless reciprocating fluid machine as claimed in claim 1 wherein the reinforcement plate is porous.

26. An oilless reciprocating fluid machine as claimed in claim 1 wherein the reinforcement plate has a mesh.

27. An oilless reciprocating fluid machine as claimed in claim 1 wherein the reinforcement plate contains fibers.
